(19) United States
(12) Patent Application Publication
(10) Pub. No.: US 2008/0223946 A1
(43) Pub. Date: Sep. 18, 2008

(54) Gas Control/Block Valve and Automatic Circulation Device of Warm Water Using the Gas Valves

(76) Inventor: Young-Gyu Rho, Jeollabuk-do (KR)

Correspondence Address: ROBERT E. BUSHNELL, 1522 K STREET NW, SUITE 300, WASHINGTON, DC, 20005-1202, US

(21) Appl. No.: 10/586,189

(22) PCT Filed: Sep. 7, 2004
(86) PCT No.: PCT/KR2004/002265

§ 371 Date: Jul. 14, 2006

(30) Foreign Application Priority Data
Jan. 14, 2004 (KR) 10-2004-0002600

(51) Int. Cl. F24D 3/00; F16K 1/32

(52) U.S. Cl. 237/8 A; 251/324

(57) ABSTRACT

The present invention relates to gas controlling and blocking valves and An automatic warm water circulator using the same, and includes a circulation cycle formed such that a reservoir is connected to a boiler by a supply pipe, the boiler is connected to a heat exchanger by a discharge pipe, and the reservoir is connected to the heat exchanger by a circulation pipe, a hollow combustion chamber provided in the lower side of the boiler and having both sides protruded toward the outside of the boiler, a gas supply and ignition device for supplying the gas to the inside of the combustion chamber and for burning the gas to heat water in the boiler, and a supply valve and discharge valve respectively provided in the supply pipe and the discharge pipe and automatically opened and closed in response to the inner pressure for the boiler. Since the gas is controlling and blocking valves and the automatic warm water circulator using the same uses portable gases as a heat source for producing and circulation warm water, the automatic warm water circulator can conveniently supply the warm water to various heaters even outdoors where it is difficult to use electric power.

### TECHNICAL FIELD

The present invention relates to gas control valves and gas blocking valves and an automatic warm water circulator using the same, and more particularly, to gas control valves and gas blocking valves for automatically controlling and blocking gas in response to temperature changes using elastic force of springs and vapor pressure, and to an automatic warm water circulator for controlling supply of gas in response to the internal temperature changes of a boiler using the gas control valves and the gas blocking valves and for automatically producing and circulating warm water using valves opened and closed by inner vapor pressure of the boiler and only gas as a heat source without a circulation pump or other devices such that warm water is continuously supplied to heaters, such as floors, bedcovers, coverlets, blankets, car seats, underfloor heaters, or the like, and hot pads used in physical therapy, and particularly, can use portable gas as a heat source to conveniently produce and supply warm water to the heaters.

### BACKGROUND ART

In the conventional manner of supplying heat to floors, hot pads, or the like, electricity is generally utilized, the conventional blankets, floors, or hot pads to be electrically heated are effective as one of various methods of providing local heating.

However, since the electrical heater uses an electric heating wire as its heat source, electromagnetic waves harmful to the human body are generated. Research has shown that the minimum intensity of electromagnetic waves harmful to the human body is between 2 mG and 4 mG. Considering this, the intensity of electromagnetic waves generated from the electric heater ranges from 50 mG to a value exceeding 1,000 mG.

As described above, since the conventional electric heater has a shortcoming in that it is harmful to human health, use by pregnant women and nursing mothers as well as ordinary people is being limited. In order to solve the above problem, the applicant of this patent application has filed a Korean Patent Application with the Korean Intellectual Property Office on Oct. 15, 2003, entitled “Automatic warm water circulator” (Application No. 10-2003-0071615).

Since the automatic warm water circulator in the patent application solves the above problem and is in no way harmful to health, but uses an electric heater as a heat source to produce and circulate warm water, the automatic warm water circulator is difficult to operate outdoors, such as at camping areas, amusement parks, or the like, where it is difficult to supply electricity. In consideration of this problem, the applicant of this patent application has developed an automatic warm water circulator for automatically producing and circulating warm water without electricity.

### DISCLOSURE

### Technical Problem

Therefore, the present invention has been made in view of the above problems, and it is an object of the present invention to provide a gas control valve and a gas blocking valve in which valve pistons automatically move up and down due to an elastic force and vapor pressure to automatically control quantity of gas or block gas.

Another object of the present invention is to provide an automatic warm water circulator for adjusting the temperature of a boiler using the above gas control valve and the above gas blocking valve, for continuously producing and supplying warm water by taking advantage of the vapor pressure change occurring when water in the boiler is transformed into vapor and valves automatically opened and closed according to vapor pressure change without a separate power source, capable of securing safety and achieving low manufacturing costs, and particularly, for conveniently supplying warm water to various heaters, even outdoors, using portable gas as a heat source for producing and circulating warm water.

### Technical Solution

In accordance with an aspect of the present invention, the above and other objects can be accomplished by the provision of a gas control valve including a hollow valve case including a gas intake port formed at the upper side thereof, a gas discharge port formed at the side thereof, an upper inclined end having a narrow upper side and a wide lower side, and a protruded intermediate side, a valve piston, inserted into the valve case to move upward and downward, with which an O-ring for sealing the space between the valve case and the valve piston is coupled, a compression spring inserted into the space between the valve piston and the protruded intermediate side to apply a force to push the valve piston down, and a heat exchanger, installed on the bottom of the valve case, for increasing vapor pressure to apply a force to the valve piston to be pushed upward such that the gas control valve automatically adjusts the quantity of gas in response to the heat transferred to the heat exchanger.

The present invention also provides a gas blocking valve including a hollow valve case including a gas discharge port formed at the side thereof, a gas intake port formed below the gas discharge port, and a protruded intermediate side, a valve piston, inserted into the valve case to move upward and downward, with which an O-ring for sealing the space between the valve case and the valve piston is coupled, a compression spring inserted into the space between the valve piston and the protruded intermediate side to apply a force to push the valve piston down, and a heat exchanger, installed on the bottom of the valve case, for increasing vapor pressure to apply a force to the valve piston to be pushed upward such that the gas blocking valve automatically blocks gas in response to the heat transferred to the heat exchanger.

In accordance with an aspect of the present invention, the above and other objects can be accomplished by the provision of an automatic warm water circulator using gas valves, including a circulation cycle formed such that a reservoir is connected to a boiler by a supply pipe, the boiler is connected to a heat exchanger by a discharge pipe, and the reservoir is connected to the heat exchanger by a circulation pipe, a hollow combustion chamber provided in the lower side of the boiler and having both sides protruded toward the outside of the boiler, a gas supply and ignition device for supplying the gas to the inside of the combustion chamber and for burning the gas to heat water in the boiler, and a supply valve and a discharge valve respectively provided in the supply pipe and the discharge pipe and automatically opened and closed in response to the inner pressure of the boiler.

Preferably, the gas supply and ignition device includes a main nozzle provided in the combustion chamber and connected to a gas container by a main gas pipe to eject the supplied gas, a pilot igniter for igniting the gas ejected from the main nozzle, and a gas control valve, provided in the main gas pipe, for automatically controlling the quantity of the gas to be supplied to the main nozzle according to the temperature of the boiler.

The gas supply and ignition device further includes a gas blocking valve, installed in the main gas pipe to be connected to the gas control valve in serial, for automatically blocking the gas to be supplied to the main nozzle according to the temperature of the boiler.

The combustion chamber includes protruded ends formed in the upper outer circumference thereof, and air intake ports, coupled with both end of the combustion chamber, through which air necessary for combustion of the gas is introduced.

The pilot igniter includes a pilot nozzle connected to a pilot supply pipe branched from the main gas pipe and installed near to the main nozzle, and including a pilot lighter connected to a pilot switch such that the pilot nozzle ignites the gas ejected from the main nozzle while the pilot nozzle flames.

The reservoir includes an opening for opening a part of the upper side of the reservoir, an opening and closing device provided at the opening and having a ventilation hole, and an air pack, installed in the opening and closing device, for sealing the opening and being contracted and expanded due to the pressure difference between the inner pressure of the reservoir and an external pressure by the opening.

The air pack may be provided in the upper or lower surface of the opening and closing device.

The automatic warm water circulator using gas control/blocking valves is characterized in that air pack accommodates water.

### ADVANTAGEOUS EFFECTS

As described above, since the gas control valve and the gas blocking valve according to the present invention automatically adjust the quantity of gas and block gas due to heat transmitted from the outside, the gas control valve and the gas blocking valve usefully serve as a controller and a safe device for controlling gas supply in various devices using gas as a heat source.

Moreover, the automatic warm water circulator uses the gas control valve and the gas blocking valve as a temperature adjustor and a safety device, uses valves automatically opened and closed by vapor pressure generated when water in a boiler is transformed into vapor and in response to vapor pressure change such that the automatic water circulator continuously produces and circulates warm water without using a separate driving power, and does not pose a health risk. Therefore, the automatic warm water circulator can be safely and conveniently utilized in heating daily necessities such as blankets, carpets, floors, and to provide a heat source for microbiological laboratory work incapable of heating at a close distance using electric heaters, and of using motor pumps, and in medical instruments. In particular, since the automatic warm water circulator according to the present invention uses portable gases as a heat source for producing and circulating the warm water, the automatic warm water circulator can conveniently supply the warm water to various heaters even outdoors where it is difficult to use electric power.

### DESCRIPTION OF DRAWINGS

The above and other objects, features and other advantages of the present invention will be more clearly understood from the following detailed description taken in conjunction with the accompanying drawings, in which:

FIG. 1 is a schematic view illustrating the structure and the opened and closed states of a gas control valve according to the present invention;

FIG. 2 is a schematic view illustrating the structure and the opened and closed states of a gas blocking valve according to the present invention;

FIG. 3 is a schematic view illustrating the overall structure of an automatic warm water circulator using gas valves according to a preferred embodiment of the present invention;

FIGS. 4, 5, and 6 are schematic views illustrating a supply valve and a discharge valve employed in the automatic warm water circulator according to the preferred embodiment of the present invention;

FIGS. 7 and 8 are schematic views illustrating a combustion chamber of the automatic warm water circulator according to the preferred embodiment of the present invention;

FIG. 9 is a schematic view illustrating a gas supplier and an ignition device employed in the automatic warm water circulator according to the preferred embodiment of the present invention;

FIG. 10 is a perspective view illustrating a reservoir employed in the automatic warm water circulator according to the preferred embodiment of the present invention; and

FIGS. 11 and 12 views illustrating examples of a pressure adjustor using an air pack employed in the automatic warm water circulator according to the preferred embodiment of the present invention.

### BEST MODE

Hereinafter, the automatic warm water circulator according to the preferred embodiments of the present invention will be described in detail with reference to the accompanying drawings.

It should be appreciated that the accompanying drawings have been disclosed for illustrative purposes of the preferred embodiments of the present invention, and the accompanying drawings and the description with reference to the drawings do not restrict the present invention.

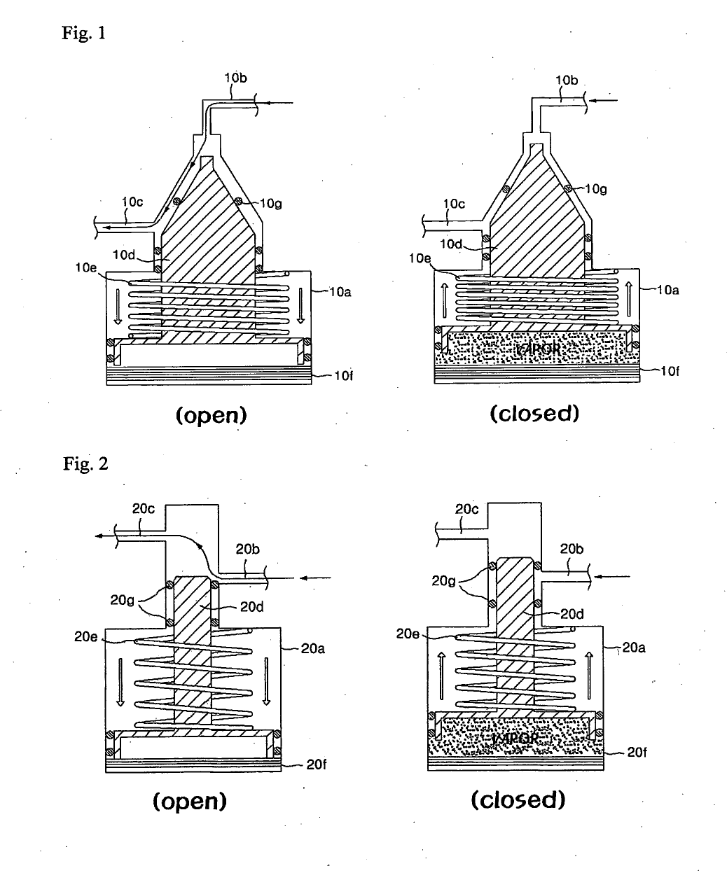

FIG. 1 is a schematic view illustrating the structure and the opened and closed states of a gas control valve 10 according to the present invention. As shown in the drawing, the gas control valve 10 includes a valve case 10a, a gas intake port 10b, a gas discharge port 10c, a valve piston 10d, a compression spring 10e, and a heat exchanging plate 10f.

The valve case 10a has a shape in which a sectional area of the valve case 10a is gradually increased from the upper side to the intermediate side of the valve case 10a to form a slope and the intermediate side protrudes such that a sectional area from the intermediate side to the lower side thereof is constant and the interior thereof is hollow.

The gas intake port 10b where gas is introduced is formed at the upper side of the valve case 10a, and the gas discharge port 10c for discharging gas is formed in the slope.

The valve piston 10d is inserted into the valve case 10a such that the valve piston 10d is inserted into the compression spring 10d to apply a force to push the valve piston 10d down, and the heat exchanging plate 10f is installed the bottom of the valve case 10a, that is, the lower side of the valve piston 10d to apply a force to push the valve piston 10d upward.

Here, a predetermined amount of water fills a space between the heat exchanging plate 10f and the valve piston 10d such that the water is transformed into vapor when external heat is transferred to the water through the heat exchanging plate 10f and a predetermined vapor pressure is generated. Thus, the valve piston 10d is pushed upward due to the vapor pressure.

The automatic operation of the gas control valve 10 is described in detail as follows. The gas control valve 10 is installed to contact a device serving as a heat source such that the heat is easily transferred thereto through the heat exchanging plate 10f installed on the bottom of the valve case 10a.

Since the vapor pressure formed between the valve piston 10d and the heat exchanging plate 10f is low when the temperature of the device serving as a heat source is low, the valve piston 10d is lowered by elastic force of the compression spring 10e such that the gas control valve is opened.

In other words, as shown in the drawing, since there is a sufficient space between the valve piston 10d and the vale case 10a where gas flows, the gas introduced into the space through the gas intake port 10b is discharged through the gas discharge port 10c.

When the gas control valve 10 is opened and the heat source is heated due to the supplied gas and its temperature is increased and exceeds 100 degrees centigrade, the water between the valve piston 10d and the heat exchanging plate 10f is transformed into vapor due to the heat transferred to the heat exchanging plate 10f from the heat source to form the vapor pressure, and the valve piston 10d compresses the compression spring 10e and ascends due to the force of the vapor pressure.

As described above, when the valve piston 10d continuously ascends, the space, where the gas introduced through the gas intake port 10b flows, is gradually narrowed, the quantity of the discharged gas is decreased. When the temperature of the device serving as a heat source is decreased due to the decreased quantity of the supplied gas, the force due to the vapor pressure is less than the force of the compression spring 10e and the valve piston 10d descends. As a result, the quantity of the supplied gas is increased again such that the quantity of the supplied gas is automatically adjusted according to the temperature of the device serving as a heat source.

If, although the valve piston 10d ascends and the quantity of the supplied gas is decreased, the temperature of the heat exchanging plate 10f is increased rather than decreased, the vapor pressure in the space between the heat exchanging plate 10f and the valve piston 10d is further increased, and, as shown in the drawings, the valve piston 10d ascends further such that piston O-rings 10g of the valve piston 10d closely contact the valve case 10a to prevent the introduction of gas. Thereby, the gas supply is completely blocked.

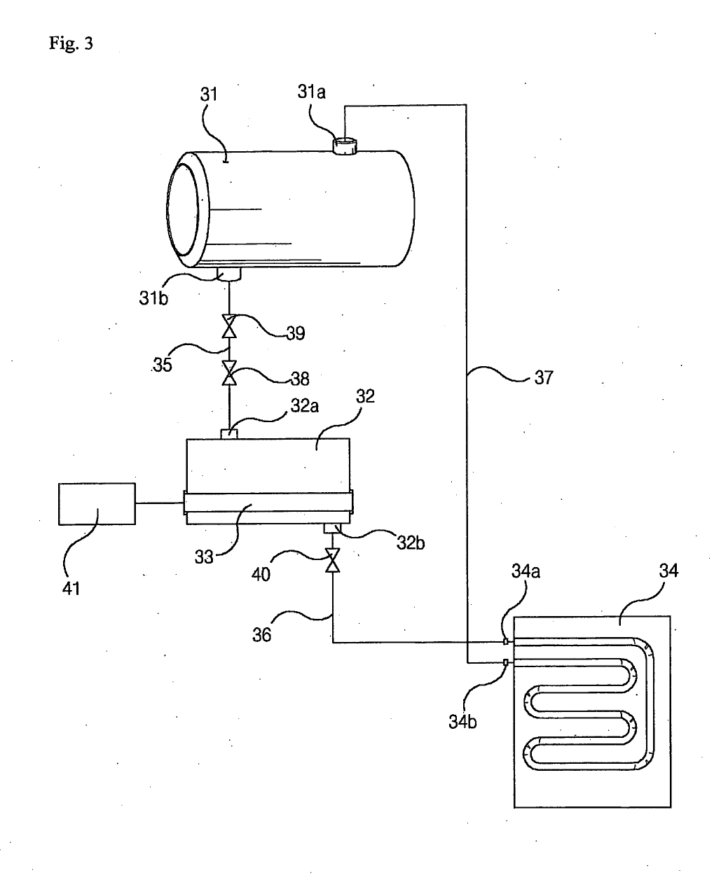

FIG. 2 is a schematic view illustrating the structure and the opened and closed states of a gas blocking valve 20 according to the present invention. As shown in the drawing, the gas blocking valve 20 includes a valve case 20a, a gas intake port 20b, a gas discharge port 20c, a compression spring 20e, and a heat exchanging plate 20f.

The valve case 20a has a shape such that a sectional area from the upper side to the intermediate side thereof is constant, the intermediate side protrudes, and a sectional area from the protruded intermediate side to the lower side thereof is constant. The inside of the valve case 20a is empty, that is, the valve case 20a is a hollow cylinder, and it is preferred that the valve case 20a is installed to contact the device serving as a heat source like the gas control valve 10.

The gas intake port 20b is formed in the side above the protruded intermediate side of the valve case 20a and the gas discharge port 20c is formed in the side of the valve case 20a higher than the gas intake port 20b.

The structure of the gas blocking valve 20 and the performance thereof for blocking gas according to heat transferred to the heat exchanging plate 20f are identical to those of the gas control valve 10 described above. In other words, when the temperature of the heat exchanging plate 20f is low, the valve piston 20d descends due to the compression spring 20e and the gas blocking valve 20 is opened to introduce and discharge the gas.

Moreover, when the supplied gas is burnt such that the temperature of the device serving as a heat source is increased and the vapor pressure in the space between the valve piston 20d and the heat exchanging plate 20f is formed, the valve piston 20d ascends to close the gas blocking valve 20 and to block the gas supply.

However, since, in the gas blocking valve 20, the upper sides of the valve case 20a and the valve piston 20d have constant sectional areas different from those of the valve case 10a and the valve piston 10d of the gas control valve 10, as shown in the drawing, although the valve piston 20d ascends due to the vapor pressure formed when the temperature transferred to the heat exchanging plate 20f is increased, the quantity of gas cannot be reduced when positions of the piston O-rings 20g coupled with the valve piston 20d are lower than the position of the gas intake port 20b, but gas is immediately blocked when the valve piston 20d further ascends such that the positions of the piston O-rings 20g are higher than the position of the gas intake port 20b.

In other words, the performance of the gas blocking valve 20 for adjusting the quantity of the supplied gas in response to the temperature transferred from the outside is weak in comparison with the performance of the gas control valve 10, but the gas blocking valve 20 only performs the function of blocking the gas supply. Thus, when the gas blocking valve 20 is utilized in conjunction with the gas control valve 10, the gas blocking valve 20 preferably serves as a safety device for preventing an exterior device from being overheated by blocking gas when the gas control valve 10 malfunctions.

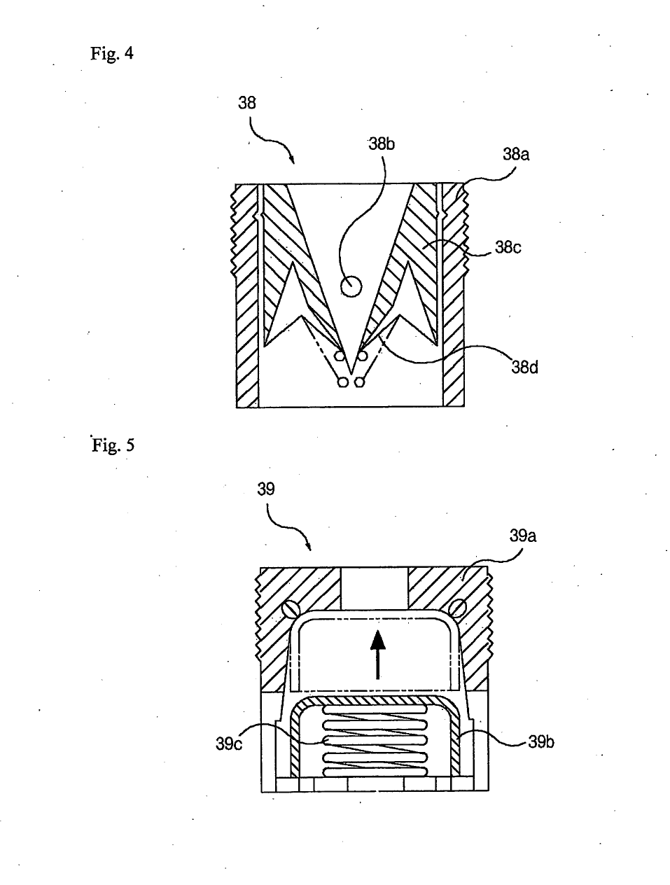

FIG. 3 is a schematic view illustrating the overall structure of an automatic warm water circulator using gas valves according to a preferred embodiment of the present invention.

As shown in the drawing, the automatic warm water circulator using gas valves according to a preferred embodiment of the present invention includes a reservoir 31 for supplying cool water and storing the circulated cool water, a boiler 32 for receiving the cool water from the reservoir 31 and for discharging warm water, and a heat exchanger 34 for using the warm water as a heat source and for transferring heat to the outside. The reservoir 31 is connected to the boiler 32 by a supply pipe 35, the boiler 32 is connected to the heat exchanger 34 by a discharge pipe 36, and the heat exchanger 34 is connected to the reservoir 31 by a circulation pipe 37 such that a circulation cycle is formed.

The boiler 32 includes a combustion chamber 33 for heating the cool water in the boiler 32 by burning gas. A gas supply and ignition device 41 is connected to the combustion chamber 33 and the supply pipe 35 and the discharge pipe 36 include supply valves 38 and 39 and a discharge valve 40, which are automatically opened and closed due to the vapor pressure in the boiler 32 to control the supply of cool water and the discharge of warm water.

The reservoir 31 is usually used to store water and includes a water intake port 31a formed in the upper side of the reservoir 31, through which circulated and returned cool water is introduced, and a water discharge port 31b formed in the lower side thereof for discharging cool water to the boiler 32. The reservoir 31 is preferably installed at a position higher than the boiler 32 such that the cool water in the reservoir 31 is easily discharged to the supply pipe 35 due to gravity.

The boiler 32 includes a water supply port 32a formed in the upper side thereof and connected to the supply pipe 35, through which cool water is introduced from the reservoir 31, and a water discharge port 32b formed in the lower side thereof and connected to the discharge pipe 36, through which warm water is discharged.

Here, the boiler 32 includes a bottom surface preferably inclined at 3 degrees to 5 degrees toward the water discharge port 32b. The reason for the inclined bottom surface of the boiler 32 is that the warm water is easily discharged from the boiler 32 to prevent water vapor from being discharged from the boiler during the discharge of the warm water and to reduce noise.

The heat exchanger 34 includes a water intake port 34a connected to the water discharge port of the boiler 32 by the discharge pipe 36 and a water discharge port 34b connected to the reservoir 31 by the circulation pipe 37 such that the heat exchanger 34 receives the warm water from the discharge pipe 36, transfers heat to the exterior, and circulates the cool water to the reservoir 31 through the circulation pipe 37. The heat exchanger 34 is applied to various heaters such as mats, quilts, or the like, and preferably includes connectors for easily performing the connection and disconnection of the pipes.

The supply valves 38 and 39 according to the present invention are respectively a cone-type supply valve and a cylinder-type supply valve, which are connected to the supply pipe 35 in serial fashion.

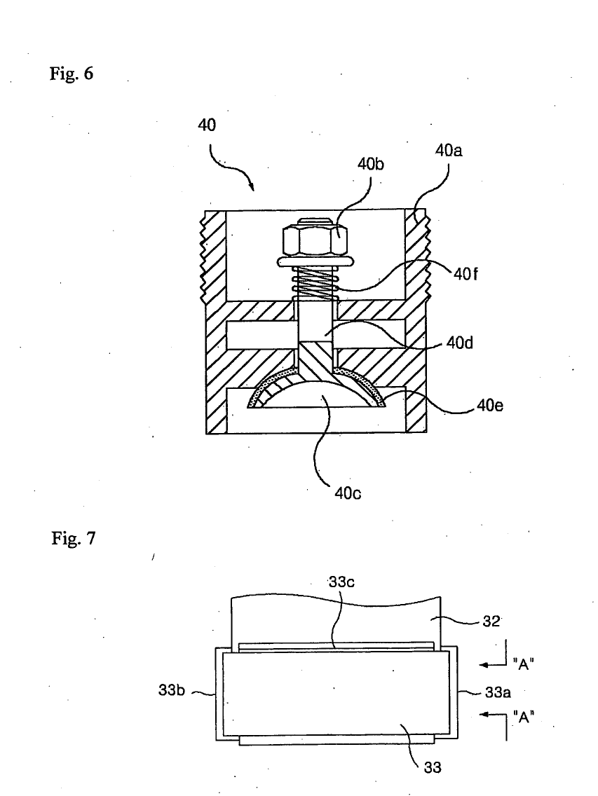

FIG. 4 is a schematic view illustrating the structure of the cone-type supply valve 38. As shown in the drawing, the cone-type supply valve 38 includes a valve case 38a, a valve diaphragm support 38c that is installed in the valve case 38a, and has a water supply port 38b formed in the cone-shaped outer surface thereof having a wide upper side and a narrow lower side, a valve diaphragm 38d fixed between the valve case 38a and the valve diaphragm 38c and having a lower end moved upward and downward due to an external force.

The cone-type supply valve 38 blocks leakage of the water vapor such that the lower end of the valve diaphragm 38d loosely contacts the inclined surface of the valve diaphragm support 38c in a normal state, and the lower end of the valve diaphragm 38d is pushed down to closely contact the inclined surface of the valve diaphragm support 38c due to the vapor pressure generated when the cool water supplied from the reservoir 31 is heated and transformed into the water vapor.

When the pressure within the boiler 32 is low after discharging all warm water in the boiler 32, the valve diaphragm 38d descends to open the cone-type supply valve 38 so that the cool water is supplied to the boiler 32.

FIG. 5 is a schematic view illustrating the cylinder type supply valve according to the present invention, and, as shown in the drawing, includes a valve case 39a, a valve body 39b installed in the valve case 39a and freely moved upward and downward, and a spring 39c having one end fixed to the lower side of the valve case 39a and the other end coupled with the inner upper side of the valve body 39b to provide an elastic force for raising the valve body 39b.

The cylinder type supply valve 39 prevents the leakage of the vapor pressure in the boiler 32 such that the valve body 39b loosely contacts the valve case 39a due to the elastic force of the spring 39c in the normal state, and the valve body 39b closely contacts the valve case 39a due to the vapor pressure generated when the cool water in the boiler 32 is heated and transformed into water vapor. When the pressure within the boiler 32 is low after discharging all warm water in the boiler 32, the spring 39c descends and the valve body 39b moves downward to open the cylinder-type supply valve 39 so that the cool water in the reservoir 31 is supplied to the boiler 32.

The above two supply valves 38 and 39 can assist one another when any one of them is damaged or malfunctions due to foreign matter, so that normal warm water circulation can be performed.

Since time for supplying the cool water is determined according to the elastic force of the valve diaphragm 38d of the cone-type supply valve 38 and the elastic modulus of the spring 39c of the cylinder type supply valve 39, the elastic force of the valve diaphragm 38d and the strength of the spring 39c must be selected within a proper range. Preferably, the elastic force of the valve diaphragm 38d and the strength of the spring 39c are slightly greater than the sum of the weight of the cool water in the supply pipe 35 supplied from the reservoir 31 and the weight of the valve diaphragm 38d, or the weight of the valve body 39c itself, and are the extent that the cone-type supply valve 38 is slightly closed when none of external load is applied thereto. Moreover, since the vapor pressure in the boiler 32 is rapidly decreased after all warm water is discharged from the boiler 32, if the supply valves 38 and 39 are not sufficiently large, time for supplying water is prolonged and frictional noise may be generated. Thus, preferably, in order to reduce the noise, the proper sizes of the supply valves 38 and 39 are selected.

FIG. 6 is a schematic view illustrating a discharge valve employed in the present invention, the discharge valve 40, as shown in the drawing, includes a valve case 40a, a valve stem 40d penetrating a hole formed in the valve case 40a and having one end to which a nut 40b is fixed and the other end in which a valve head 40c is formed, a valve diaphragm cover 40e coupled with the valve head 40c to provide a seal between the inner hole of the valve case 40a and the valve head 40c, and a compression spring 40f, fitted around the valve stem 40d, compressed and fixed by the nut 40b, for providing elastic force to the valve diaphragm cover 40e to closely contact the hole of the valve case 40a.

The discharge valve is closed by the compression spring 40f in the normal state, and is opened by the valve stem 40d moved down when the vapor pressure is greater than the elastic force of the compression spring 40f so as to discharge warm water in the boiler 32 to the discharge pipe 36.

In other words, the discharge valve 40 is closed when the vapor pressure of the boiler 32 is less than the elastic force of the compression spring 40f and is opened when the vapor pressure of the boiler 32 is greater than the elastic force of the compression spring 40f, that is, the discharge valve 40 is automatically opened and closed by the vapor pressure.

Since, when the strength of the compression spring of the discharge valve 40 is increased, the vapor pressure in the boiler 32 for discharging the warm water is also increased, in order to supply the warm water to elevated or distant areas, increased strength of the compression spring 40f is needed. However, in this case, an excessive increase in the temperature of the water vapor results in sluggish circulation of the warm water. Therefore, the strength of the compression spring 40f is preferably selected within a proper range. In particular, when the strength of the compression spring 40f is too weak, the supply of the warm water is completed before the temperature in the boiler 32 is sufficiently increased, and there is no water vapor for lowering the pressure in the boiler 32 after supplying the warm water, such that the warm water cannot be automatically produced and circulated. Therefore, it is important to properly select the strength of the compression spring 40f.

Moreover, the discharge valve 40 can adjust temperature of the produced warm water by the strength of the compression spring 40f. In other words, since high vapor pressure is needed to open the discharge valve 40 when increasing the strength of the compression spring 40f, warm water temperature is increased. On the contrary, when the strength of the compression spring 40f is low, the warm water temperature is relatively decreased too.

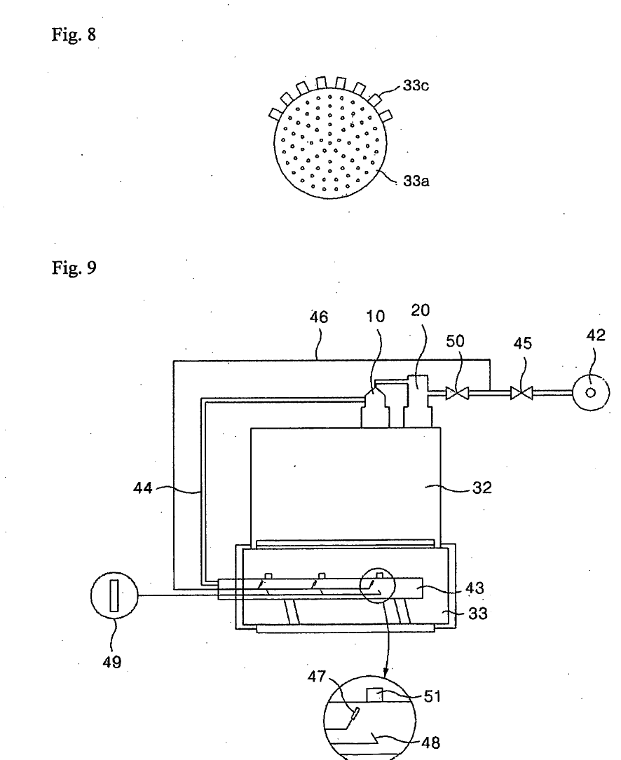

FIGS. 7 and 8 are schematic views illustrating the structure of the combustion chamber 33 of the automatic warm water circulator according to the preferred embodiment of the present invention. As shown in FIG. 7, the combustion chamber 33 is installed such that both ends of the combustion chamber 33 are protruded outwardly by a predetermined distance and are extended on the lower side of the boiler 32.

The protruded ends of the combustion chamber 33 are coupled with air intake ports 33a and 33b and a plurality of radiator-shaped protrusions 33c is formed on the upper outer circumference of the combustion chamber 33.

The air intake ports 33a and 33b coupled with the ends of the combustion chamber 33, as shown in FIG. 8, are formed with minute holes through which air passes such that air necessary for burning gas in the combustion chamber 3 is introduced into the combustion chamber 33. However, since the introduced air may disturb the gas combustion or may extinguish the gas flame when the quantity of air introduced into the combustion chamber 33 through the air intake ports 33a and 33b is large, it is preferable to puncture the minute holes with diameters equal to or less than 0.5 mm such that the exact quantity of air necessary for burning gas can be introduced into the combustion chamber 33.

The outer circumference of the combustion chamber 33, as shown in FIG. 8, is preferably formed with the radiator-shaped folded protrusions 33c. The radiator-shaped protrusions 33c effectively transfer heat generated by burning gas in the combustion chamber 33 to water contacting the outer circumference of the combustion chamber 33 so as to enhance thermal efficiency.

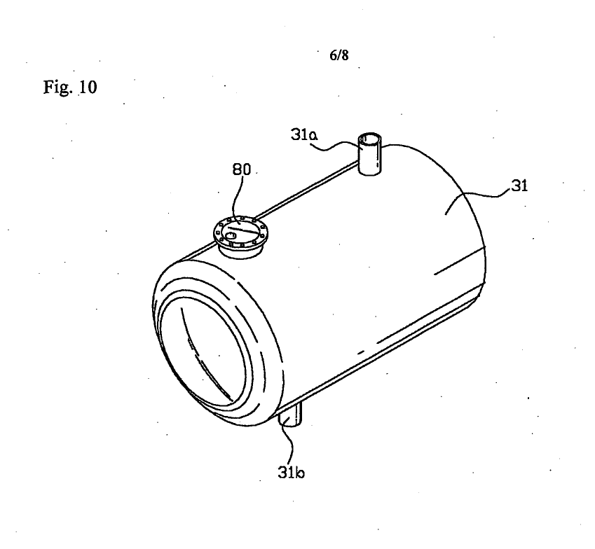

FIG. 9 is a schematic view illustrating the structure of the gas supply and ignition device 41. As shown in the drawing, the gas supply and ignition device 41 includes a gas container 42, a main nozzle 43 provided in the combustion chamber 33, a main gas pipe 44 for connecting the gas container 42 with the main nozzle 43, a main gas valve provided in the main gas pipe 44, a pilot gas pipe 46 branched from the main gas pipe 44, a temperature adjusting valve 50 provided on the rear side of the main gas pipe 44 where the pilot gas pipe 46 is branched from the main gas pipe 44, a pilot lighter 48 and a pilot switch 49 serving as ignition devices, and the gas control valve 10 and the gas blocking valve 20, which are constructed as above.

The gas container 42 is a vessel for storing gas serving as a heat source of the automatic warm water circulator according to the preferred embodiment of the present invention, may be a usual container such as a butane gas canister for a portable gas burner, an LPG canister for a gas range, or the like.

The gas container 42 is connected to the main gas pipe 44 to supply gas to the main nozzle 43. The main gas pipe 44 includes the main gas valve 45, the temperature adjusting valve 50 installed at the rear side thereof where the pilot gas pipe 46 is branched, and the gas blocking valve 20 and the gas control valve 10 installed at the rear side of the temperature adjusting valve 50 in serial.

The main gas valve 45 is a manually operated valve for supplying gas to the main nozzle 43 and blocking gas flowing from the gas container 42 to the main nozzle 43, and is preferably manipulated only when starting and stopping the automatic warm water circulator. Since the main gas valve 45 is manually opened and closed, gate valves generally used as opening and closing valves may serve as the main gas valve 45.

The temperature adjusting valve 50 is provided at the rear side of the main gas pipe 44 where the pilot gas pipe 46 is branched. Since the temperature adjusting valve 50 is closed when the main gas valve 45 is initially opened, gas is supplied only through the pilot gas pipe 46. By doing so, gas supplied through the pilot gas pipe 46 is supplied to the main nozzle 43 after turning the pilot switch 49 on ignites the pilot nozzle 47. Since there is danger of gas explosion, fire, or the like, when the pilot nozzle 47 is ignited after a substantial quantity of gas is supplied into the combustion chamber 33 through the main gas pipe 44 prior to the ignition of the pilot nozzle 47, such danger can be prevented by supplying gas to the main nozzle 43 after the ignition of the pilot nozzle 47. Moreover, the quantity of gas supplied to the main nozzle 43 is controlled by adjusting the opening degree of the temperature adjusting valve 50, thereby adjusting the temperature of the warn water produced and circulated.

The gas control valve 10 and the gas blocking valve 20 are installed such that their lower sides contact the surface of the boiler 32 and automatically block gas supply from the gas container 42 and/or adjust the quantity of gas supplied to the main nozzle 43 due to the elastic forces of the compression springs 10e and 20e and the vapor pressure generated by heat transferred from the boiler 32.

In other words, when the temperature of the boiler 32 is not high, the valve pistons 10d and 20d of the gas control valve 10 and the gas blocking valve 20 are pushed down by the compression springs 10e and 20e such that gas is supplied to the main nozzle 43 of the combustion chamber 33. As such, when the temperature of the boiler 32 exceeds 100 degrees centigrade due to combustion of the supplied gas during continuous gas supply, water in the space between the valve pistons 10d and 20d and the heat exchanging plates 10f and 20f is transformed into water vapor to generate vapor pressure. Due to the vapor pressure, the valve pistons 10d and 20d ascend to compress the compression springs 10e and 20e such that the quantity of gas supplied to the main nozzle 43 is reduced. As described above, when the temperature of the boiler 32 is increased and exceeds 105 degrees centigrade even when the gas supply is reduced, the valve pistons 10d and 20d further ascend to completely block gas supply to the main nozzle 43.

The gas control valve 10 can block the gas supply when the boiler 32 is overheated during the adjustment of the quantity of gas, and the gas blocking valve 20 serves as a safety device when the gas control valve 10 malfunctions.

The main nozzle 43 includes a plurality of ejection nozzles 51 for ejecting gas supplied from the gas container 42. The ejection nozzles 51 are fixedly installed on the bottom surface of the combustion chamber 33 of the boiler 32 by a nozzle support and are connected to the gas container 42 via the main gas pipe 44. The number of ejection nozzles 51 is preferably selected in accordance with the volume of the boiler 32 such that proper vapor pressure can be generated in the boiler 32.

The pilot nozzle 47 is installed near the ejection nozzles 51 of the main nozzle 43 and is connected to the main gas pipe 44 via the pilot gas pipe 46 to eject gas supplied from the gas container 42.

Here, since the pilot gas pipe 46 connected to the pilot nozzle 47 is connected to the main gas pipe 44 between the main gas valve 45 and the gas blocking valve 20, the pilot gas pipe 46 continuously receives gas when the main gas valve 45 is opened regardless of operation of the gas blocking valve 20 and/or the gas control valve 10. However, the diameter of the pilot gas pipe 45 is significantly less than that of the main gas pipe 44, and thus the quantity of gas ejected through the pilot nozzle 47 is also significantly less than the quantity of gas ejected through the main nozzle 43.

The pilot lighter 48 is installed near the pilot nozzle 47 and is connected to the pilot switch 39 such that the pilot lighter 48 generates a spark to ignite gas ejected from the ejection nozzles 51 when the pilot switch 49 is operated.

The spark generated by the pilot lighter 48 ignites the pilot nozzle 47 and flame of the ignited pilot nozzle 47 ignites gas ejected from the ejection nozzles 51 of the main nozzle 43 such that water in the boiler 32 is heated.

Meanwhile, since gas is independently supplied to the pilot nozzle 47 and the main nozzle 43 as described above, gas is continuously supplied to the pilot nozzle 47 even when the gas control valve 10 or the gas blocking valve 20 provided in the main gas pipe 44 is operated and gas supply to the main nozzle 43 is blocked.

Thus, since the gas control valve 10 or the gas blocking valve 20 stops the gas combustion at the main nozzle 43 but gas is continuously supplied to the pilot nozzle 47, flame is maintained during the operation of the automatic warm water circulator according to the preferred embodiment of the present invention. However, since only a small quantity of gas is supplied to the pilot nozzle 47, flame of the pilot nozzle 47 does not cause the temperature of the boiler 32 to increase and merely ignites gas supplied again to the main nozzle 43.

Operation of the automatic warm water circulator using gas valves according to the preferred embodiment of the present invention constructed as described above will be described as follows.

At first, the reservoir 31* is filled with cool water and the temperature adjusting valve 50 is submerged in the water, and then the main gas valve 45 is opened. After that, the pilot switch 49 is turned on and the temperature adjusting valve 50 is opened to ignite the main nozzle 43. Then, air in the boiler 32 is expanded to increase inner pressure of the boiler 32. If the discharge valve 40 is opened when the inner pressure of the boiler 32 is continuously increased, a part of air in the boiler 32 is discharged and the temperature of the boiler 32 is continuously increased.

When the temperature of the boiler 32 is further increased and exceeds 100 degrees centigrade, the gas control valve 10 and the gas blocking valve 20 are closed such that gas supply to the main nozzle 32 is blocked. Thus, the temperature of the boiler 32 is decreased and the inner pressure of the boiler 32 is also decreased.

At this time, since gas is continuously supplied to the pilot nozzle through the pilot gas pipe 46 even when flame of the main nozzle 43 is turned off due to the interception of gas supplied to the main nozzle 43, flame of the pilot nozzle 47 is not turned off but is maintained.

As described above, when the inner pressure of the boiler 32 is reduced to become low pressure to overcome the elastic force of the valve diaphragm 38d of the cone-type supply valve 38 and the strength of the spring 39c of the cylinder-type supply valve 39, the supply valves 38 and 39 are opened such that the cool water in the reservoir 31 is started to be supplied to the boiler 32 through the supply pipe 35.

When the boiler 32 is filled with cool water, the surface temperature of the boiler 32 is lowered below 100 degrees centigrade and the gas control valve 10 and the gas blocking valve 20 are opened again to supply gas to the main nozzle 43.

When gas is supplied as described above, the flame of the pilot nozzle 47 ignites gas ejected from the main nozzle 43 and the boiler 32 is heated again.

When the cool water in the boiler 32 is heated and reaches a temperature of about 75 degrees centigrade, the vapor pressure is generated in the boiler 32. At this time, the supply valves 38 and 39 of the supply pipe 35 are closed to prevent the initial vapor pressure in the boiler 32 from leaking out of the boiler 32.

When the vapor pressure in the boiler 32 is further increased due to continued heating, the supply valves 38 and 39 are more firmly closed due to the vapor pressure. When the warm water temperature is continuously increased such that the vapor pressure in the boiler 32 is higher than the strength of the spring of the discharge valve 40, the discharge valve 40 is opened and the warm water in the boiler 32 begins to be discharged through the discharge pipe 36.

When the warm water begins to be discharged, the level of the warm water in the boiler 32 is gradually lowered and the vapor pressure in the boiler 32 is continuously increased. When all warm water in the boiler 32 is discharged, since it is difficult to transfer heat generated due to the flame of the main nozzle 43 through gas, the vapor pressure in the boiler 32 is decreased rather than is increased. If, at this time, the vapor pressure in the boiler 32 is not decreased but the boiler 32 is overheated after all warm water is discharged, the gas control valve 10 and the gas blocking valve 20 are, of course, closed to block gas supply.

As such, when the vapor pressure in the boiler 32 is lowered such that the inner pressure of the boiler 32 is low, the supply valves 10 and 20 are automatically opened to supply cool water to the boiler 32 again.

When cool water is supplied to the boiler 32 again, the supplied cool water rapidly cools the boiler 32 and the inner pressure of the boiler 32 is reduced. Due to decrease of the inner pressure of the boiler 32, the supply valves 38 and 39 are fully opened to sufficiently supply cool water to the boiler 32.

The warm water discharged from the boiler 32 is supplied to the heat exchanger 34 through the discharge pipe 40.

The heat exchanger 34, to which warm water is supplied, transfers heat to the outside from the warm water as a heat source. Cool water cooled after the heat transfer is discharged through the circulation pipe 37.

The cool water discharged through the circulation pipe 37 is circulated to and stored in the reservoir 31. After that, the cool water is supplied to the boiler 32 in the same fashion as described above such that a warm water circulation cycle is automatically completed.

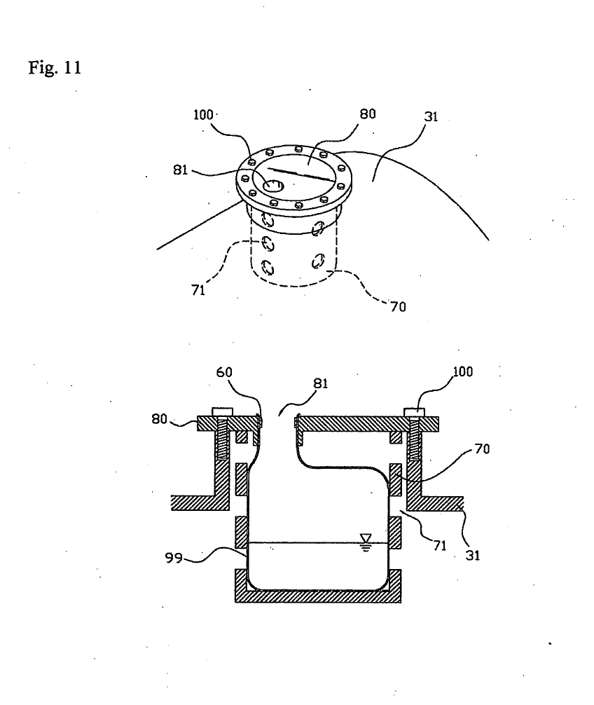

Meanwhile, FIG. 10 is a perspective view illustrating the reservoir 31 employed in the automatic warm water circulator according to the preferred embodiment of the present invention. When the reservoir 31 is sealed, the inner pressure of the reservoir 31 may be reduced in proportion to the vapor pressure due to the quantity of water discharged from the reservoir 31, and may be minutely reduced due to thermal expansion of high temperature water. Thus, the reservoir 31 may be stressed repeatedly. For the purpose of solving this problem, since water stored in the reservoir 31 is evaporated when a part of the reservoir 31 is opened, supplemental water must be supplied periodically.

Therefore, in the automatic warm water circulator according to the preferred embodiment of the present invention, the reservoir 31 has an opening 31a* for opening a part of the upper side of the reservoir 31, and an air pack 99 that is contracted and expanded due to inner pressure change of the reservoir 31 to adjust the difference between the internal pressure and external pressure of the reservoir 311.

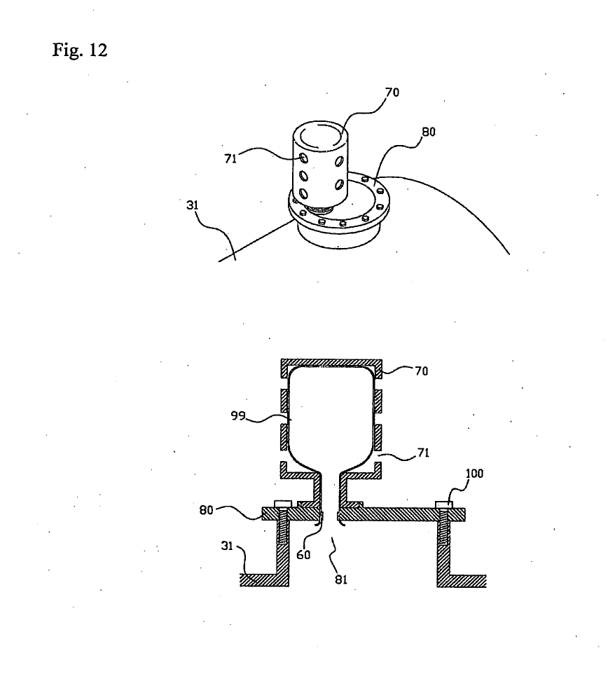

In other words, as shown in FIG. 11, the reservoir 31 is formed with the opening 31a* for opening a part of the upper side of the reservoir 31, and an opening and closing device 80 for opening and closing the opening 31a* is fixed to the reservoir 31 by a fastening device such as a bolt 100. Here, the opening and closing device 80 is formed with a ventilation hole 81. The opening and closing device 80 has a cylindrical support 70 for supporting the air pack 99 to maintain its shape and having a plurality of penetrating holes 71. The reason for forming the penetrating holes 71 is to provide space in which the air pack 99 can be expanded.

The air pack 99 is accommodated in the support 70 and the support 70 is fixed to the lower surface of the opening and closing device 80. At that time, the opening part of the air pack 99 is inserted into the ventilation hole 81 and an attaching ring 60 is inserted into the opening part of the air pack 99 such that the air pack 99 is fixed to the opening and closing device 80. The air pack 99 may have a cylindrical shape. When the support 70, in which the air pack 99 is accommodated, is coupled with the opening and closing device 80, the opening and closing device is fixed to the upper opening 31a of the reservoir 31 by the bolts 100, or the like.

As such, the air pack 99 seals the opening 81 and shields the reservoir 31 to separate the reservoir 31 into an inner space and an outer space if the inside of the reservoir 31 is pressed when the air pack 99 is installed to the opening and closing device 80, the air pack 99 may act to disturb water circulation, and, as a result, the warm water in the boiler 32 is not completely discharged. Thus, preferably, the air pack 99 having a predetermined volume is installed in the opening and closing device 80 and its shape is elastically changed according to pressure change such that the air pack 99 is contracted or expanded.

When the inner pressure is lowered due to the discharge of water in the reservoir 31, the air pack 99 is expanded toward the reservoir 31. Also, when the inner pressure is increased due to the thermal expansion or the volume expansion of water in the reservoir 31, the air pack 99 is contracted outwardly. As such, the balance between the inner pressure and the external pressure of the reservoir 31 is adjusted by the contraction and expansion of the air pack 99. Since the reservoir 31 is shielded, water loss due to water vapor can be prevented. Thus, no supplemental water is needed and dust and noxious matter are prevented from being dissolved in the water in the reservoir 31.

Meanwhile, the air pack 99 may accommodate a small quantity of water. For example, since heat of the reservoir 31 is directly transferred to the air pack 99 when temperature of the reservoir 31 is increased, for effective heat transfer, the air pack 99 may accommodate a small quantity of water.

Since heat exchange is rapidly performed in the form of heat conduction and heat convection through the air pack 99, chemical deformation and damage of the air pack 99 due to the temperature change can be prevented.

As shown in FIG. 12, the air pack 99 may be installed in the upper side of the reservoir 31. In other words, though the opening and closing device 80 is coupled with the reservoir 31 in the same or similar fashion as described above, the opening and closing device 80 is firstly coupled with the reservoir 31 and the support 70, in which the air pack 99 is installed, is coupled with the upper surface of the opening and closing device 80.

As such, the air pack 99 is installed outside the reservoir 31. Thus since the air pack 99 can be replaced simply by separating the support 70 without detachment of the opening and closing device 80, the air pack 99 is more convenient to use and for the maintenance than the case that the air pack 99 is installed in the reservoir 31.

### INDUSTRIAL APPLICABILITY

Although the preferred embodiments of the automatic warm water circulator according to the present invention have been disclosed for illustrative purposes, it is understood that the technical scope of the present invention is not limited to the above description and those skilled in the art will appreciate that various modifications, additions and substitutions are possible, without departing from the scope and spirit of the invention as disclosed in the accompanying claims.

Therefore, various modifications, additions and substitutions are possible within the scope and spirit of the invention as disclosed in the accompanying claims.

1. A gas control valve comprising:
a hollow valve case including a gas intake port formed at the upper side thereof, a gas discharge port formed at the side thereof, an upper inclined end having a narrow upper side and a wide lower side, and a protruded intermediate side;
a valve piston, inserted into the valve case to move upward and downward, with which an O-ring for sealing the space between the valve case and the valve piston is coupled;
a compression spring inserted into the space between the valve piston and the protruded intermediate side to apply a force to push the valve piston down; and
a heat exchanger, installed on the bottom of the valve case, for increasing vapor pressure to apply a force to the valve piston to be pushed upward such that the gas control valve automatically adjusts the quantity of gas in response to the heat transferred to the heat exchanger.

2. A gas blocking valve comprising:
a hollow valve case including a gas discharge port formed at the side thereof, a gas intake port formed below the gas discharge port, and a protruded intermediate side;
a valve piston, inserted into the valve case to move upward and downward, with which an O-ring for sealing the space between the valve case and the valve piston is coupled;
a compression spring inserted into the space between the valve piston and the protruded intermediate side to apply a force to push the valve piston down; and
a heat exchanger, installed on the bottom of the valve case, for increasing vapor pressure to apply a force to the valve piston to be pushed upward such that the gas blocking valve automatically blocks gas in response to the heat transferred to the heat exchanger.

3. An automatic warm water circulator using gas valves, comprising:
a circulation cycle formed such that a reservoir is connected to a boiler by a supply pipe, the boiler is connected to a heat exchanger by a discharge pipe, and the reservoir is connected to the heat exchanger by a circulation pipe;
a hollow combustion chamber provided in the lower side of the boiler and having both sides protruded toward the outside of the boiler;
a gas supply and ignition device for supplying the gas to the inside of the combustion chamber and for burning the gas to heat water in the boiler; and
a supply valve and a discharge valve respectively provided in the supply pipe and the discharge pipe and automatically opened and closed in response to the inner pressure of the boiler.

4. The automatic warm water circulator using gas valves as set forth in claim 3, wherein the gas supply and ignition device comprises:
a main nozzle provided in the combustion chamber and connected to a gas container by a main gas pipe to eject the supplied gas;
a pilot igniter for igniting the gas ejected from the main nozzle; and
a gas control valve, provided in the main gas pipe, for automatically controlling the quantity of the gas to be supplied to the main nozzle according to the temperature of the boiler.

5. The automatic warm water circulator using gas valves as set forth in claim 4, further comprising:
a gas blocking valve, installed in the main gas pipe to be connected to the gas control valve in serial, for automatically blocking the gas to be supplied to the main nozzle according to the temperature of the boiler.

6. The automatic warm water circulator using gas valves as set forth in claim 3, wherein the combustion chamber includes:
protruded ends formed in the upper outer circumference thereof; and
air intake ports, coupled with both end of the combustion chamber, through which air necessary for combustion of the gas is introduced.

7. The automatic warm water circulator using gas valves as set forth in claim 4, wherein the pilot igniter comprises:
a pilot nozzle connected to a pilot supply pipe branched from the main gas pipe and installed near to the main nozzle, and including a pilot lighter connected to a pilot switch such that the pilot nozzle ignites the gas ejected from the main nozzle while the pilot nozzle flames.

8. The automatic warm water circulator using gas valves as set forth in claim 3, wherein the reservoir comprises:
an opening for opening a part of the upper side of the reservoir;
an opening and closing device provided at the opening and having a ventilation hole; and
an air pack, installed in the opening and closing device, for sealing the opening and being contracted and expanded due to the pressure difference between the inner pressure of the reservoir and an external pressure by the opening.

9. The automatic warm water circulator using gas valves as set forth in claim 8, wherein the air pack is provided in the upper or lower surface of the opening and closing device.

10. The automatic warm water circulator using gas valves as set forth in claim 8, wherein the air pack accommodates water.
